(19) United States
(12) Patent Application Publication
(10) Pub. No.: US 2021/0195822 A1
(43) Pub. Date: Jul. 1, 2021

(54) METHOD AND CONTROL DEVICE FOR OPERATING AN AGRICULTURAL MACHINE

(71) Applicant: ZF Friedrichshafen AG, Friedrichshafen (DE)

(72) Inventors: Markus Birk, Friedrichshafen (DE); Luis Fernando Guerreiro, Curitiba (BR); Diogo Garcia de Freitas, Curitiba (BR); Tiago Kazunori Nagy, Friedrichshafen (DE); Mauro Cesar Zanella, Friedrichshafen (DE)

(21) Appl. No.: 16/756,472

(22) PCT Filed: Oct. 10, 2018
(86) PCT No.: PCT/EP2018/077553

§ 371 Date: Apr. 16, 2020

(30) Foreign Application Priority Data
Oct. 26, 2017 (DE) 10 2017 219 201.1

(51) Int. Cl. A01B 69/04; A01B 79/00; G05D 1/02

(52) U.S. Cl. CPC A01B 69/008; G05D 2201/0201; G05D 1/0278; A01B 79/005

(57) ABSTRACT

A method for operating an agricultural machine includes applying provided machine data of a work flow along a working route for an autonomous operation of the agricultural machine. The provided machine data includes a plurality of data sets. The method further includes recording, during the autonomous operation of the agricultural machine, a working position of the agricultural machine, and selecting and applying, as a function of the detected working position, a respective data set from the plurality of data sets of the provided machine data as a function of the detected working position.

### CROSS REFERENCE TO RELATED APPLICATIONS

This application is a U.S. National Stage Application under 35 U.S.C. § 371 of International Application No. PCT/EP2018/077553 filed on Oct. 10, 2018, and claims benefit to German Patent Application No. DE 10 2017 219 201.1 filed on Oct. 26, 2017. The International Application was published in German on May 2, 2019 as WO 2019/081205 A1 under PCT Article 21(2).

### FIELD

The invention relates to a method for operating an agricultural machine or other self-propelled machinery, including applying provided machine data of a work flow along a working route for the autonomous operation of the agricultural machine, and wherein the machine data provided has a plurality of data sets.

The invention further relates to a control device for autonomously operating an agricultural machine, wherein the device controls the agricultural machine with provided machine data of a work flow, and wherein the machine data provided has a plurality of data sets.

### BACKGROUND

An agricultural machine can be a machine, vehicle or device used on the land or in forests in the agricultural sector, in particular a mobile agricultural machine. For example, the agricultural machine can be a tractor.

An agricultural machine operating in autonomous operation may also be referred to as a self-propelled agricultural machine, that is, an agricultural machine that is not actively guided by a person. An agricultural machine operating in autonomous operation can also be a remote-controlled agricultural machine.

Autonomously operating or self-propelled agricultural machines are known from the prior art, which machines execute certain works successively starting from a starting point along a predetermined route. For example, tractors or mowing machines operating in this way, which process a programmed sequence of work tasks individually in sequence, for example with an attached mowing unit, are known.

### SUMMARY

In an embodiment, the present invention provides a method for operating an agricultural machine. The method includes applying provided machine data of a work flow along a working route for an autonomous operation of the agricultural machine. The provided machine data includes a plurality of data sets. The method further includes recording, during the autonomous operation of the agricultural machine, a working position of the agricultural machine, and selecting and applying, as a function of the detected working position, a respective data set from the plurality of data sets of the provided machine data as a function of the detected working position.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a flowchart of an embodiment of a method for operating an agricultural machine;

FIG. 2 illustrates a data structure of provided machine data for the method for operating an agricultural machine in FIG. 1.

FIG. 3 illustrates a representation of components of an embodiment of the control unit for operating an agricultural machine.

### DETAILED DESCRIPTION

Solutions for autonomously operating an agricultural machine, which in particular increase or improve the efficiency, flexibility and automation of the operation, are disclosed.

In disclosed methods, in the autonomous operation of the agricultural machine, a working position of the agricultural machine is detected and a data set is selected and used from the provided machine data as a function of the detected working position.

When a data set is used in autonomous operation, the automatic control of longitudinal dynamics and/or transverse dynamics of the agricultural machine can be carried out. When a data set is used in autonomous operation, a control of an attachment can also be carried out.

Machine data may in principle be any data for guiding, controlling or regulating the operation of an agricultural machine. The machine data for operating the agricultural machines may include, in particular, vehicle control data, driving dynamics data, auxiliary drive data (PTO data), add-on data or location-related data.

Vehicle dynamics data or vehicle control data may include vehicle positions, vehicle speeds or vehicle accelerations, for example. The driving dynamics data or the vehicle control data may also include data relating to a working path or trajectory, working time, energy expenditure, driving forces, performance, for example an engine speed, or movement resistances. The data may be location-dependent or time-dependent.

Auxiliary drive data may be data for a switchable mechanical propulsion source or power take-off shaft at an auxiliary output of the transmission. In principle, data can be stored for any attachment. The auxiliary drive data may include, for example, data for driving a mower bar mounted on the agricultural machine.

Attachment data can be data for controlling an attachment, with which, for example, the state or the orientation of a front or rear lifter can be described. The attachment data can also be used directly for controlling the attachment.

Location-related data may be machine coordinates, machine orientations, vectorial data or coordinates of a trajectory. The location-related data can be related to a local coordinate system or to a global coordinate system, for example to geographic latitudes and longitudes.

A temporal or local sequence of work tasks can be understood as the work flow. The work flow can be executed along a working route, that is to say a known route in the terrain. A working route can be a three-dimensional or a two-dimensional route. Work tasks can be carried out at specific working positions as corresponding terrain points or terrain coordinates.

A data set can be understood to be a group or collection of content-related data fields.

Proposed solutions are based on the finding that, for the automated operation of an agricultural machine, it may not be sufficient to record a work flow along a working route only in a user-guided operation and then simply play the recorded work flow in an autonomous operation.

Instead, based on an actual position of the agricultural machine at the beginning or during autonomous operation, a basic concept is to perform work tasks stored in the machine data with positional accuracy and, in particular, also independently of the data sequence. This can be advantageous, since the work machine can thus be started at any position along the working route, for example. A further advantage can consist of the fact that the local drifting of the agricultural machine from its working route or the circumnavigating of an obstacle can be continuously corrected or managed.

According to an embodiment, a recording of the provided machine data is provided in a user-guided operation of the agricultural machine. The user-guided operation can also be defined as a learning phase for the automation of the work flow to be executed by the agricultural machine. In user-guided operation, a driving of the agricultural machine or a behavior of a driver or machine operator, in particular the controlling or regulating of the agricultural machine, can be logged or copied to a data carrier. In user-guided operation, operating data of the agricultural machine or control data of devices for field processing can also be stored on a data carrier. The recording of machine data in a user-guided operation has the advantage that the preceding actual use of an agricultural machine by a farmer can be repeated or replayed with positional accuracy in a subsequent autonomous operation of the agricultural machine, without the farmer being in the agricultural machine.

In user-guided operation, the machine data can be read by a bus system and subsequently stored on a data carrier. In autonomous operation, the stored data can be communicated back to the bus system in order to allow the agricultural machine to operate automatically.

With the recording of a work flow in a user-guided operation and the repetition of the same work flow in autonomous operation, for example, operations repeated hourly or weekly can be performed automatically with an agricultural machine by a farmer. Thus, for example, the repeated process of tedding or mowing can be carried out by an agricultural machine itself.

Alternatively or additionally, the machine data provided can also be provided by the simulation of the work flow on a digital terrain model or also by a user-guided parallel operation of another agricultural machine. It is also possible to provide the machine data in a simulation platform.

According to an embodiment, the machine data provided has position data and a comparison of the recorded working position with the position data is provided for selecting the data set in autonomous operation. The position data may be two-dimensional or three-dimensional coordinates in a local or global coordinate system. A position can be defined, for example, by a geographical length and width. In addition, a position can also have height information. The position data can be individual positions, with which respective operating data or field working data are locally incurred or are to be handled in user-guided operation.

In the autonomous operation of the agricultural machine, such a data set can be selected and applied from the machine data provided, the position data of which contains a position which has the smallest distance with the working position recorded in autonomous operation. The data set which is spatially closest to the actual vehicle position during operation of the agricultural machine can thus be selected from the machine data. The Euclidean distance between a working position and the position data can be calculated.

According to an embodiment, a continuous recording of a working position of the agricultural machine in autonomous operation and a selection and an application of a respective data set from the provided machine data are provided as a function of the respectively recorded working position. The respective data set can be selected and applied independently of the sequence of data sets in the provided machine data. Alternatively, a respective data set can also be selected and applied as a function of the respectively recorded working position and as a function of the sequence of the data sets in the provided machine data. In the autonomous operation of the agricultural machine, a respective data set can thus be selected and applied continuously in a continuous loop from the provided machine data, which data set contains a position which has the smallest distance with the working position currently recorded in autonomous operation. A continuous recording or determination of the working position is advantageous since, based thereon, location-dependent work tasks described in the machine data can be continuously selected with positional accuracy and can be executed by the agricultural machine.

According to an embodiment, a time emitter is provided for recording the working position, for selecting the data set and/or for applying the data set. In this case, the time emitter prescribes the time interval at which the recording of the working position, the selection of the data set and/or the use of the data set is carried out. The time emitter may also be referred to as a timer. The recording, selection or application of data in a user-guided or autonomous operation can take place at a constant time interval, for example at an interval of 100 milliseconds. The interval may define a cycle or cycle time for performing individual work tasks or machine control information described in a data set. A constant cycle is particularly advantageous for communicating with a bus system.

A further time emitter or timer can be provided, which sends a message to a vehicle dynamics control of the agricultural machine at a further constant time interval, in particular at a shorter time interval than the distance for the recording of the working position, the selection of the data set and the application of the data set, in order to control its current speed and engine speed.

According to an embodiment, the machine data provided has speed data and, based on the data set selected as a function of the recorded working position, selection and application of one of the data sets following in the machine data provided, is provided for an idle state of the agricultural machine in autonomous operation. The subsequent data set can be selected. The idle state can also be a stoppage of the agricultural machine. The speed data may represent speeds of the agricultural machine implemented in a user-guided operation along the working route. The speed data may define target speeds for moving the agricultural machine in autonomous operation. As an alternative or in addition to speed data, the positioning data or acceleration data in the provided machine data provided can also be taken into account in order to derive speed data.

Based on the speed data present in the machine data, two different states of motion of the agricultural machine can be distinguished during autonomous operation. A first state of motion may be defined as a driving state and a second state of motion may be defined as an inactive or stationary state. As a distinguishing criterion, a speed may serve as a threshold value for delimiting the first and second states in the speed data. Speeds greater than zero may also be assigned to the standing state. The threshold value can be, for example, 3 km/h or 1.5 km/h.

If an applied or selected speed in the speed data is assigned to the first state of motion, that is to say it is above the threshold value, a data set whose position comes closest to the recorded working position can be selected and applied.

If an applied or selected speed in the speed data is assigned to the second state of motion, that is to say if it is below the threshold value, the data set following the data set most recently applied in the provided machine data can be selected and applied. A subsequent data set can be a data set that is structurally subsequent in the data structure and can also be a locally or chronologically subsequent data set.

If the agricultural machine is in the second state of motion, successive data sets can be communicated cyclically, for example every 100 milliseconds, from a file which can contain the machine data to a bus system. For example, the next row can always be placed on a CAN bus system from a text file.

Alternatively or additionally, a further state of motion can be defined between the first and second state of motion. Such state of motion may exist when speeds in the speed data are within a certain range. In this state of motion, there can be a check of whether a position of a selected data set matches the position of the subsequent data set or is similar thereto. In the case of a match or similarity, the method may be like that in the first state of motion, and in the case of no match or similarity, the method may be like that in the second state of motion.

In particular in ranges of low speeds, for example between 1.5 km/h and 3 km/h, positioning data can be very similar. In this case, a deadlock can occur when the current working position is compared with the positioning data, since an individual position is always closest to the working position in the machine data. A deadlock or a jamming denotes a state in which a cyclical wait situation occurs, wherein a new data set to be applied waits for the release of operating means for controlling the agricultural machine, which has exclusively occupied a currently applied data set.

Distinguishing such states has the advantage that an agricultural machine can also be operated in an autonomous operation in an idle state or at very low speeds. This also means that, for example, an activation procedure can be executed during a stoppage of the agricultural machine.

According to an embodiment, buffering of the provided machine data is performed prior to selecting the data set. A plurality of data sets may be loaded into a buffer by a data carrier. As an example, 50 data sets may be buffered. A data set can then be selected and applied from the data sets present in the buffer. After an analysis of at least some of the loaded data sets, the buffer can be overwritten with a further plurality of data sets. Such buffering of data is advantageous, since the read speed of a data carrier is limited and the reading of the data is thus rendered efficient.

According to an embodiment, a selection of the data set is provided from a partial data volume of the machine data provided. The partial data volume may be formed from the machine data provided or from a plurality of buffered data sets. The partial data set may comprise a plurality of data sets, for example ten data sets. The plurality of data sets may in particular have a smaller number of data sets than a plurality of buffered data sets. The working position can be compared with positioning data in a partial data volume, and the data set with the lowest positional deviation can be selected and applied. Such searching and finding of a data set in a partial data volume may have the advantage of an increased computational speed or reaction speed.

According to an embodiment, a recording of positioning data and/or the working position is provided by means of a satellite navigation system. The satellite navigation system can in particular use GPS, GLONASS and/or GALILEO satellites. A receiver for corresponding satellite signals may be provided on the agricultural machine and generate positioning data or working positions. The accuracy of the positioning data or working positions can be increased by using a reference station, for example differential GPS can be used. The use of a satellite navigation system for position detection has the advantage of a rapid and high-frequency availability of positioning information of an agricultural machine which is in motion.

According to an embodiment, the machine data provided has time data and, for selecting the data set, a comparison of the working position recorded in autonomous operation with the position data and/or a comparison of a time information recorded in autonomous operation with the time data is provided. A chronological sequence of the data sets in the provided machine data can thus be taken into account. An advantageous effect of this embodiment is that redundant or non-unique position information can also be applied in the machine data by taking into account the time information. Thus, in the case of a position-dependent comparison for selecting a data set, redundant route sections with different work tasks, also intersecting routes or overlapping routes in the working route, can be taken into account.

Time data can also be obtained from position data, in particular from position data obtained with a satellite system. For example, the time stamp of a GPS position, the GPS time, can be used for obtaining or reading out time data.

According to an embodiment, the machine data provided has land cultivation data. A device or tool provided on or attached to the agricultural machine can be controlled with land cultivation data. A selected data set can thus be used to control an attachment. The device or the tool can be controlled in a position-dependent and/or time-dependent manner during the autonomous operation of the agricultural machine. A plurality of devices can also be activated simultaneously with the land cultivation data.

For example, with an autonomously operated tractor in agriculture, a tedder can be used automatically at times or a mowing gear during mowing. For example, setpoint values of a rear lifter or a front lifter and the auxiliary drive data (PTO data) of the respective lifter can be provided as land cultivation data. This can make it possible to carry out a plurality of work tasks simultaneously and automatically.

According to an embodiment, a use of the provided machine data from a vehicle dynamics control is provided in autonomous operation. The vehicle dynamics control can regulate longitudinal dynamics and/or transverse dynamics of the agricultural machine. The longitudinal dynamics can in particular comprise the speed or the acceleration along the working route. The transverse dynamics can comprise positions or a trajectory. In the autonomous operation of the agricultural machine, the longitudinal dynamics, transverse dynamics and/or a working process along a working route can thus be flexibly regulated.

In the control unit for operating an agricultural machine in autonomous operation, an interface for a position sensor is provided for recording a working position of the agricultural machine, wherein the control unit selects and applies a data set from the provided machine data as a function of the recorded operating position. The agricultural machine can be operated with such a control unit in autonomous operation.

An interface may also be understood as an interface serving as part of the controller for communicating with other equipment or devices.

Furthermore, an interface can be provided for a bus system for the application of the selected data set. Devices can be connected to the agricultural machine via the bus system. The devices can be controlled uniformly via the bus system integrated in the agricultural machine. Corresponding control devices, for example TCU devices or ECU devices, receive the message from the bus system and convert it. A bus system has the advantage that a separate control unit does not have to be provided for each device.

According to an embodiment, an interface is provided for a data carrier, wherein the provided machine data is held on the data carrier, in particular a memory card which can be replaced by a user. For example, an SD card may be provided, on which provided machine data may be stored. A portable data carrier or one that can be replaced by the user has the advantage that machine data can be used by or on a plurality of agricultural machines for their respective autonomous operation.

An agricultural machine can have the described control unit or is operated with the method described above.

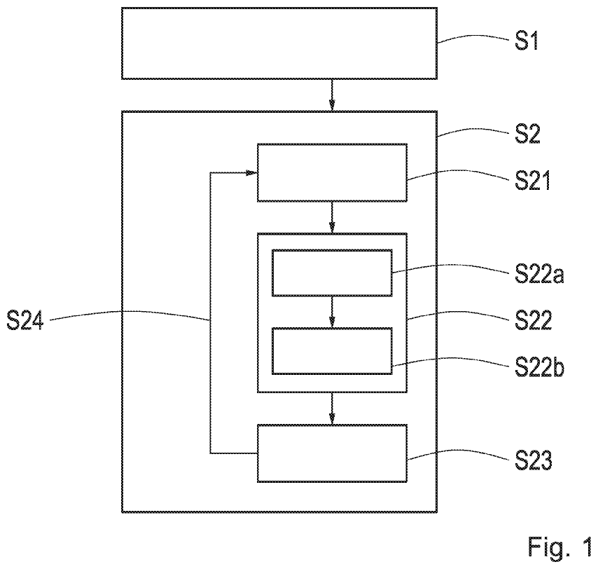

FIG. 1 schematically illustrates individual method steps of a method for operating an agricultural machine (not shown) in an autonomous operation. In a first, preceding step S1, machine data 100 is acquired in a user-guided operation. In a second, subsequent step S2, provided machine data 100 are applied by the agricultural machine in autonomous operation. Step S1 is optional since machine data 100 can also be provided without step S1 being recorded. Step S2 may also be the first step.

Step S2 has sub-steps S21, S22, S23 and S24. When machine data 100 is used in the autonomous operation of the agricultural machine, the working position of the agricultural machine is detected in a first sub-step S21, in a second sub-step S22 a data set 10 is selected from the provided machine data 100 and in a third sub-step S23 the selected data set 10 is applied, wherein the agricultural machine or an attachment (not shown) executes a specific work task.

The selection of a data set in sub-step S22 again comprises sub-steps S22a, S22b. In a first sub-step S22, machine data 100 or a plurality of data sets 10 are buffered as a partial data volume in a data buffer and, in a further sub-step S22b, a data set 10 is selected from the partial data volume of the machine data 100 buffered in step S22a. The sub-steps S22a and S22b may replace the sub-step S22.

Steps S21, S22, S23, or S21, S22a, S22b, S23 are repeated in a continuous loop S24 in order to continuously record a working position in sub-step S21, to continuously select a data set in sub-step S22 or sub-steps S22a and S22b and to continuously apply a selected data set in sub-step S23. Work tasks are thus processed autonomously based on the machine data 100 provided in a position-dependent and continuous manner by the agricultural machine.

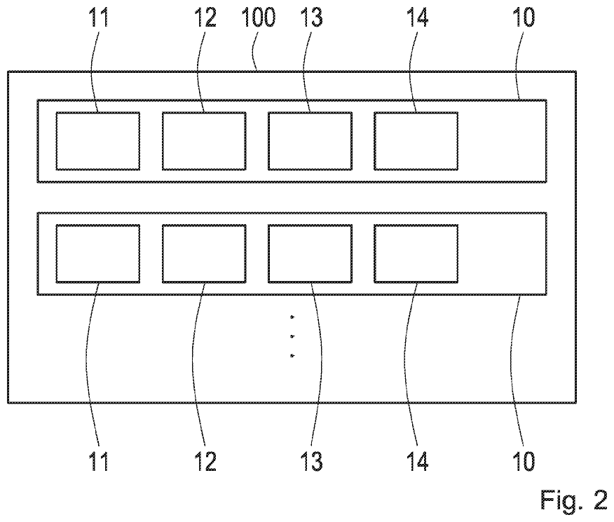

FIG. 2 schematically illustrates a data structure of the machine data 100 provided, wherein the data structure is a data structure of a text file. The machine data 100 comprises data sets 10, which are formed in the text file as a respective row.

A single data set 10 of the machine data 100 has a plurality of individual data 11, 12, 13, 14. In the illustrated embodiment, a data set 10 has time data 11, position data 12, speed data 13 and land cultivation data 14 relating to the agricultural machine. Time data 11 comprises a plurality of individual time information (not shown). The position data 12 includes a plurality of individual position information (not shown). The speed data 13 includes a plurality of individual speed information (not shown). The land cultivation data 14 comprises a plurality of individual pieces of map processing information (not shown), wherein this is used to control at least one attachment.

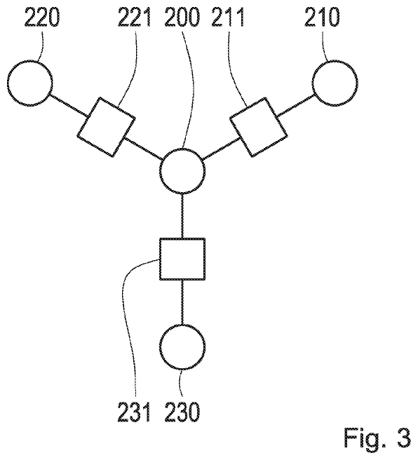

In FIG. 3, components 210, 220, 230 that are connected to control unit 200 for operating an agricultural machine are illustrated schematically. In particular, a position sensor 210, a bus system 220 and a data carrier 230, which communicate with the control unit 200 via corresponding interfaces 211, 221, 231, are provided as components. An interface 211 for the position sensor 210 is also provided. An interface 221 for the bus system 220 is also provided. An interface 231 for the data carrier 230 is provided. The control unit 200 thus communicates with the components 210, 220, 230 via the interfaces 211, 221, 231 respectively.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

S1 Recording of machine data in user-guided operation

S2 Application of machine data in autonomous operation

S21 Recording of a working position

S22 Selection of a data set

S22a Buffering of machine data

S22b Selection of a data set from a partial data volume

S23 Application of a data set

S24 Continuous recording of a working position

100 Machine data

10 Data set

11 Time data

12 Position data

13 Speed data

14 Land cultivation data

200 Control unit

210 Position sensor

211 Interface for position sensor

220 Bus system

221 Interface for bus system

230 Data carrier

231 Interface for data carrier

1. A method for operating an agricultural machine, the method comprising:
applying provided machine data of a work flow along a working route for an autonomous operation of the agricultural machine, wherein the provided machine data includes a plurality of data sets,
recording, during the autonomous operation of the agricultural machine, a working position of the agricultural machine, and
selecting and applying, as a function of the detected working position, a respective data set from the plurality of data sets of the provided machine data as a function of the detected working position.

2. The method according to claim 1, wherein provided the machine data are recorded in a user-guided operation of the agricultural machine.

3. The method according to claim 1, wherein the provided machine data comprise positioning data, and wherein the recorded working position is compared with the positioning data for selecting the respective data set in autonomous operation.

4. The method according to claim 1, wherein the working position of the agricultural machine is continuously recorded during the autonomous operation of the agricultural machine, and
wherein the respective data set from the plurality of data sets of the machine data is selected and applied as a function of the continuously recorded working position.

5. The method according to claim 1, wherein a timer is provided for recording the working position, for selecting the respective data set, and/or for applying the respective data set, wherein the timer prescribes a time interval at which the recording of the working position, the selecting of the respective data set and/or the applying of the respective data set is carried out.

6. The method according to claim 1, wherein the provided machine data comprise speed data, and wherein a respective subsequent data set in the machine data provided for an idle state of the agricultural machine in autonomous operation is selected and applied based on the respective subsequent data set selected as a function of the recorded operating position.

7. The method according to claim 1, wherein the machine data provided is buffered prior to selecting the data set.

8. The method according to claim 1, wherein the data set is selected from a partial data volume of the provided machine data.

9. The method according to claim 1, wherein position data and/or the working position is detected by a satellite navigation system.

10. The method according to claim 1, wherein the machine data provided comprise time data and,
for selecting the data set, the working position recorded in autonomous operation is compared with the positioning data and/or
time information recorded in autonomous operation is compared with the time data.

11. The method according to claim 1, wherein the machine data provided comprise land cultivation data.

12. The method according to claim 1, wherein the machine data provided are used by a vehicle dynamics control in autonomous operation.

13. A controller for operating an agricultural machine in autonomous operation, the controller being configured to:
control the agricultural machine with provided machine data of a work flow, wherein the provided machine data has a plurality of data sets;
select and apply a data set from the provided machine data as a function of a recorded operating position of the agricultural machine,
wherein an interface for a position sensor is provided for recording the operating position of the agricultural machine.

14. The control unit according to claim 13, wherein an interface for a data carrier is provided, wherein the provided machine data is stored on the data carrier.

15. A agricultural machine, which can be operated with a control unit according to claim 13 in autonomous operation.
